(19) United States
(12) Patent Application Publication
(10) Pub. No.: US 2004/0236904 A1
(43) Pub. Date: Nov. 25, 2004

(54) Data recording method and data reproducing method

(75) Inventor: Taku Hoshizawa, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/676,574

(22) Filed: Sep. 30, 2003

(30) Foreign Application Priority Data
May 19, 2003 (JP) JP 2003-139755
Jul. 7, 2003 (JP) JP 2003-192563

(51) Int. Cl. G06F 12/00

(52) U.S. Cl. 711/112; 711/163

(57) ABSTRACT

In an optical recording/reproducing device, an address of recording data showing an outermost periphery managed by the device is managed, whereby all non-recorded areas at an inner side than the recording address of the outermost periphery managed upon an additional writing prohibition process (finalization) are changed to recorded areas.

### BACKGROUND OF THE INVENTION

1. Field of the Invention

The present invention relates to a technique of recording and reproducing information with respect to an information recording medium.

In particular, the present invention relates to a technique of recording and reproducing information with respect to an information recording medium such as a write-once type optical disk.

2. Description of the Prior Arts

A DVD having a capacity of 4.7 Gbytes has appeared and spread in the market as an optical disk having high density and large capacity instead of CD. Further, standardization of a next-generation optical disk using blue laser has recently been carried out, so that new features different from those of the conventional ones are expected to be realized. Random recording is given as one of the features wherein data can be recorded on a free position without depending on the data position previously recorded, such as DVD-RAM.

In particular, in order to secure exchangeability to ROM, it is impossible to randomly record in a non-rewritable media called a write-once type optical disk such as CD-R, DVD-R or the like. Moreover, in order to give exchangeability to ROM disk, a processing called finalization is required wherein, after recording data on the disk, a TOC is recorded in the innermost periphery of a media for recording read-out. The merit of this processing is that the feature of “R-media cannot be eliminated (altered)” can be given to the write-once type media by not forming a physically free region, while this processing has a problem as a demerit that it takes much time to record the read-out.

Japanese Unexamined Patent Application Publication No. 2002-324321 discloses a method for shortening this period.

This disclosure proposes, as one of the methods for solving the abovementioned problem, a system for automatically performing a finalization processing to a recorded CD-R upon executing dubbing from a CD to a CD-R in a case where it is determined that dubbing of information on all tracks is normally completed.

Requests from the user to the write-once type optical disk include that “a recording system is not limited”, “finalization does not occur, or it does not take much time”, “alteration cannot be executed” or the like.

However, the finalization processing disclosed in Japanese Unexamined Patent Application Publication No. 2002-324321 corresponds only to a conventional system of sequential recording from the inner periphery to the outer periphery, and does not specifically propose finalization processing to a randomly-recorded optical disk.

### SUMMARY OF THE INVENTION

Therefore, the present invention provides a new finalization method of “not limiting a recording system”without losing features of “finalization does not occur or it does not take much time”, “alteration cannot be executed” or the like in an optical disk recording/reproducing device.

In an optical recording/reproducing device, an address of recording data showing the outermost periphery managed by the device is managed, whereby all non-recorded areas at the inner side than the recording address of the outermost periphery managed upon an additional writing prohibition process (finalization) are changed to recorded areas.

### BRIEF DESCRIPTION OF THE DRAWINGS

FIG. 1 are views showing an additional writing prohibition method (finalization method) of the present invention;

FIG. 2 is a view showing identification data (ID) showing additional writing prohibition data;

FIG. 3 is a view showing a processing flow composing a physical sector;

FIG. 4 is a view of a data sector;

FIG. 5 is a view of identification data (ID);

FIG. 6 is a view of CPR₁₃ MAI in a data area;

FIG. 7 is a view of an initial value of a shift register;

FIG. 8 is a view showing a configuration of a feedback shift register producing scrambling data;

FIG. 9 is a view of an ECC block;

FIG. 10 is a view of an ECC block after row-interleaving;

FIG. 11 is a view of a physical sector;

FIG. 12 is a view showing a flow of encoding of a DVD;

FIG. 13 is a view showing a DVD recording/reproducing system;

FIG. 14 are views showing a recording block and a recording position on the disk;

FIG. 15 are views showing a shape of the disk and a physical address;

FIG. 16 is a side sectional view showing a region segmentation of the disk;

FIG. 17 are views showing an MRA;

FIG. 18 are views showing an MRA;

FIG. 19 are side sectional views showing a region segmentation in a user data region;

FIG. 20 are views showing a recording state of the disk to which unauthorized recording is performed;

FIG. 21 are views showing a relationship b tween management information and an MRA;

FIG. 22 is a flowchart showing a recording sequence;

FIG. 23 is a flowchart showing a reproducing sequence;

FIG. 24 is a flowchart 1 showing an additional writing prohibition sequence;

FIG. 25 is a flowchart 2 showing an additional writing prohibition sequence;

FIG. 26 are views showing a recording block and details of 16 data sectors 3; and

FIG. 27 are views of identification data (ID) showing invalid data.

### DETAILED DESCRIPTION OF THE PREFERRED EMBODIMENT

A DVD format will be explained hereinbelow as one example of a recording format, and further, an embodiment wherein the present invention is applied to this example will be explained with reference to the drawings. It is needless to say that the present invention is applicable to many recording media including an optical disk, so the present invention is not limited to the DVD format.

A recording format of a DVD will be explained.

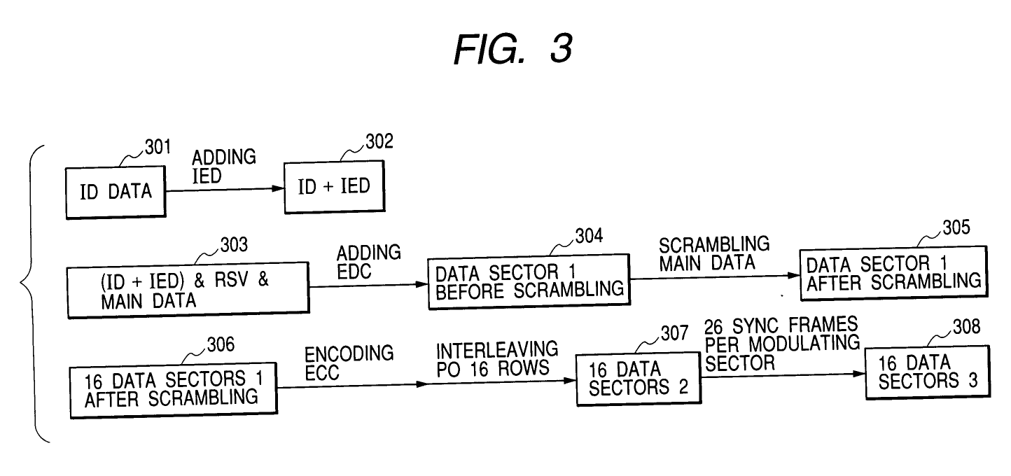

FIG. 3 shows a processing flow for forming a physical sector of the DVD.

Each sector is called data sector (data sector 1 after scrambling) 305, recording sector (data sector 2) 307 and physical sector (data sector 3) 308 in accordance with a stage of a signal process, and processed according to the processing flow (a flow of encoding processing) for composing the physical sector shown in FIG. 3.

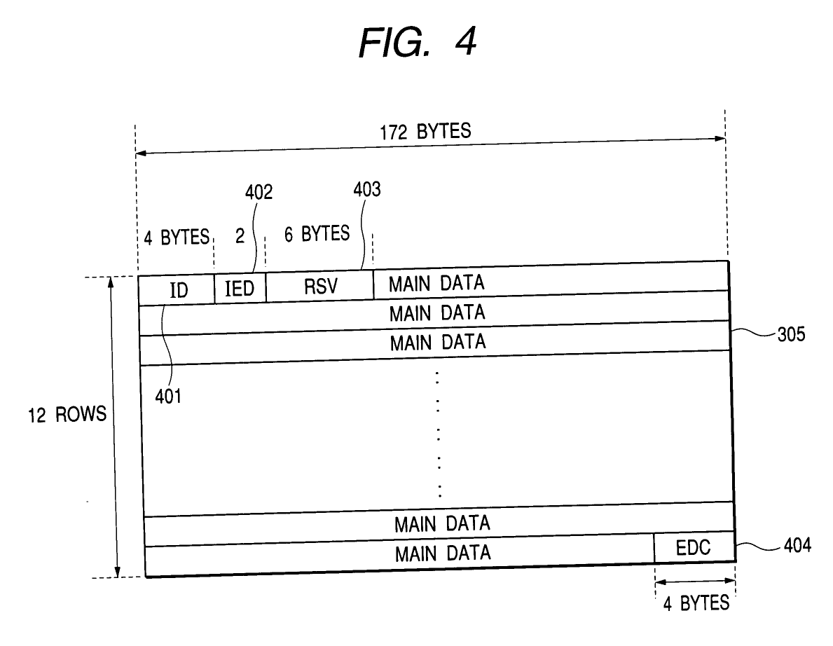

FIG. 4 is a structure of the data sector 305.

The data sector 305 is 2064 bytes of data composed of 2048 bytes of main data, 12 bytes of data identification address information such as identification data ID 401 and 4 bytes of an error detection code EDC 404, and is composed of 172 bytes×12 rows. After the calculation of the EDC, scramble data is added to 2052 bytes of the main data in the data sector 305.

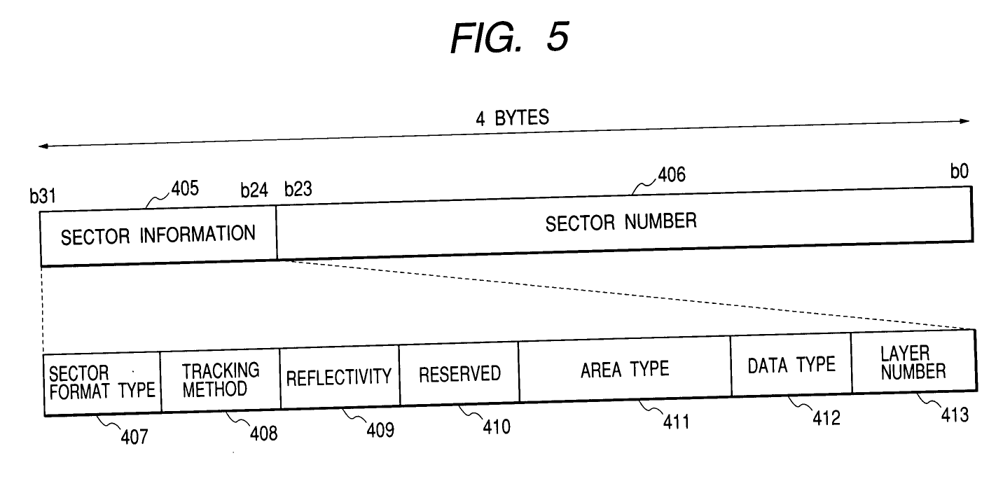

FIG. 5 is a structure of the ID 401.

The ID is composed of 3 bytes of sector information (Data Field Information) and 1 byte of a sector number (Data Field Number). The sector information 405 includes format type (Sector Format Type) information 407, tracking method information 408, reflectivity information 409 or the like on a disk. Further, it also includes area type information 411 representing a data area and read-in/read-out area, data type information 412 representing whether it is data exclusively for a reproduction or data for additional writing or rewriting and layer number information 413 representing a layer of a disk. Moreover, the sector number 406 is consecutive numbers assigned to the data area, wherein the data area is divided with 030000 h as a head.

Moreover, the EDC 404 shown in FIG. 4 is a check symbol marked on the 2060 bytes of the data sector before scrambling. It is checked by this EDC 404 that non-correctable state occurs in the data sector 305 after an error correction or whether an error is included or not by the error correction or the like.

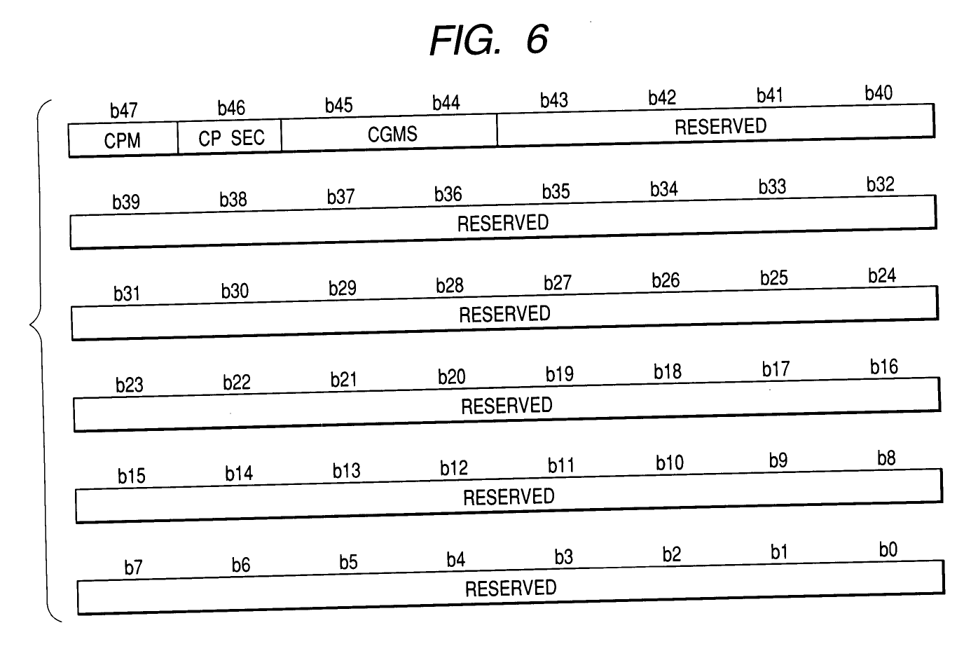

FIG. 6 shows a structure of CPR_MAI (Copyright Management Information) 403 in a case where the RSV 403 in the data area in FIG. 4 is used in a DVD-ROM. The DVD-ROM currently uses 4 bits of 48 bits. A b47 is a CPM (Copyright Material) that represents whether a material having copyright is included or not in this sector, a b46 is a CP_SEC that represents whether this sector has a special data structure of a copyright protection system, and a b45 and a b44 are CGMS (Copy Generation Management Systems) on which information about a copy limitation is recorded.

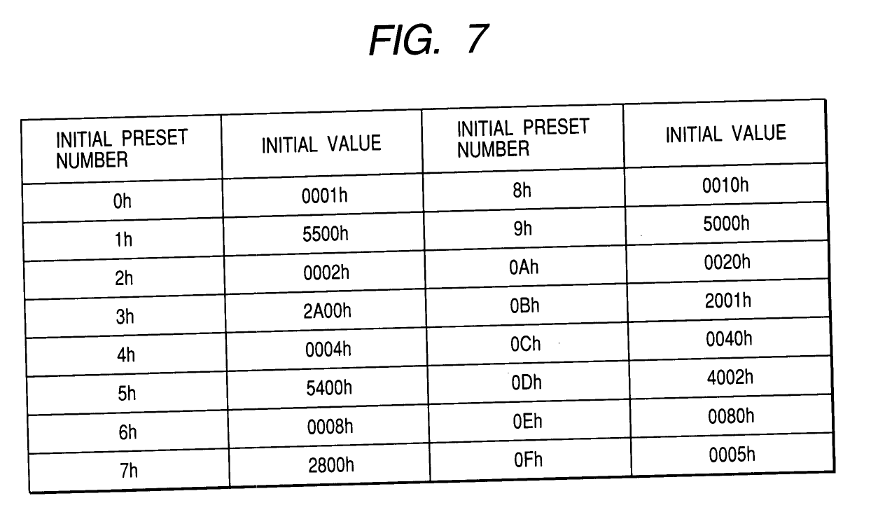

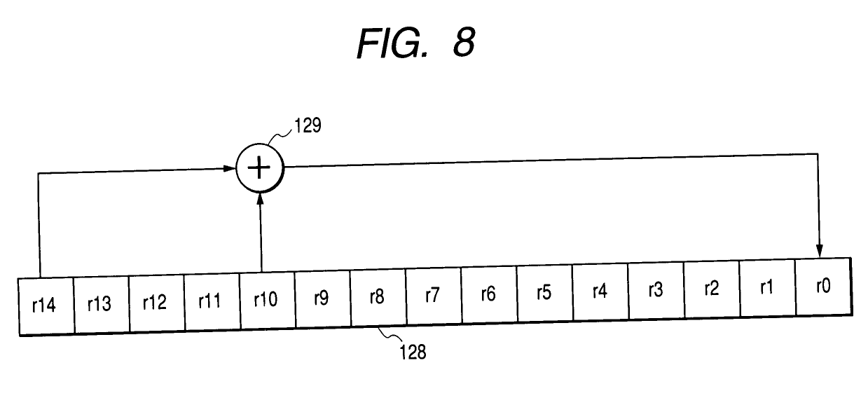

FIG. 7 shows initial values of a shift register, while FIG. 8 shows a feedback shift register for generating scrambling byte used in a scrambling process. In this figure, numeral 128 denotes a 1-bit register and 129 denotes an adder (Exclusive-OR). The scrambling byte is generated by repeating 8-bit shift with an initial value corresponding to the initial preset number shown in FIG. 7 defined as the initial value of the shift register in FIG. 8. In a DVD, the initial present number corresponds to four bits from the b7 to the b4 of the ID. Specifically, unless the ID is changed, the same scrambling byte is generated from this shift register.

Further, an error correction block (ECC) is encoded after that over 16 data sectors 305. The recording sector 307 is a sector after the error correction coding process, wherein interleaving in row units is performed with a parity of outer-code PO and parity of inner-code PI added thereto. The physical sector 308 is a sector in which a synchronization code (SYNC code) is added to the head every 91 bytes of the recording sector 307.

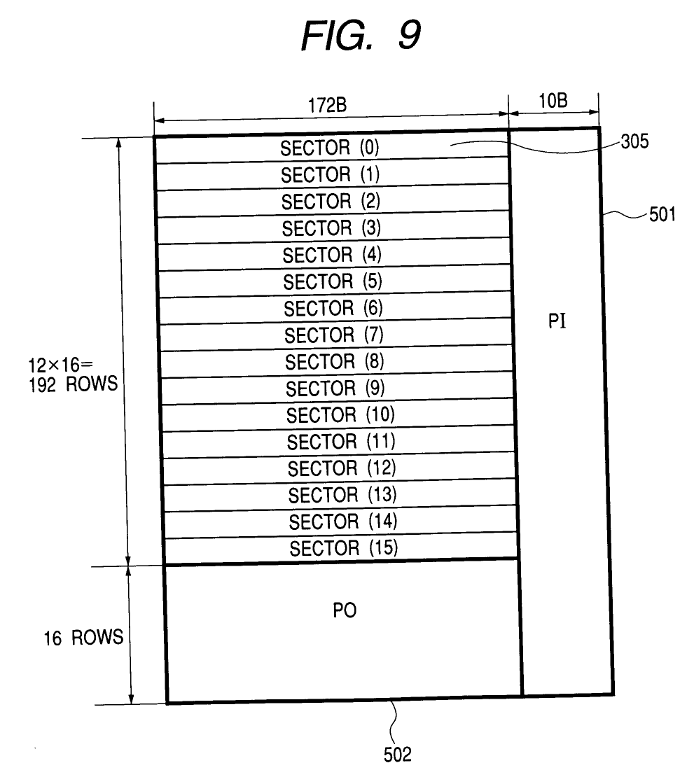

FIG. 9 is a structure of the ECC block.

This ECC block is made up of 16 data sectors 305 scrambled as an information field. 16 bytes of PO 502 is produced from a generation polynomial:

GPO(x)=(x−α0)(x−α1) . . . (x−α15)

wherein 172 bytes×192 rows equal to the 172 bytes×12 rows×16 data sectors are defined as the information field, and each column of 172 columns forms an outer-code of a Read-Solomon code RS (208, 192, 17). Subsequently, 10 bytes of PI 501 is produced from a generation polynomial:

GPI(x)=(x−α0)(x−α1) . . . (x−α9)

and all 208 rows including the PO 502 form an inner-code of a Read-Solomon code RS (182, 172, 11). The ECC block in FIG. 9 is subject to the interleaving in row units, modulated and recorded on the disk. This interleaving is performed in a manner such that the 16 PO rows are inserted one by one every 12 rows of the data area. The section of 13 rows×182 bytes in the ECC block after the interleaving is called the recording sector 307 as described abov. Accordingly, this means that the ECC block after the interleaving is composed of 16 recording sectors 307.

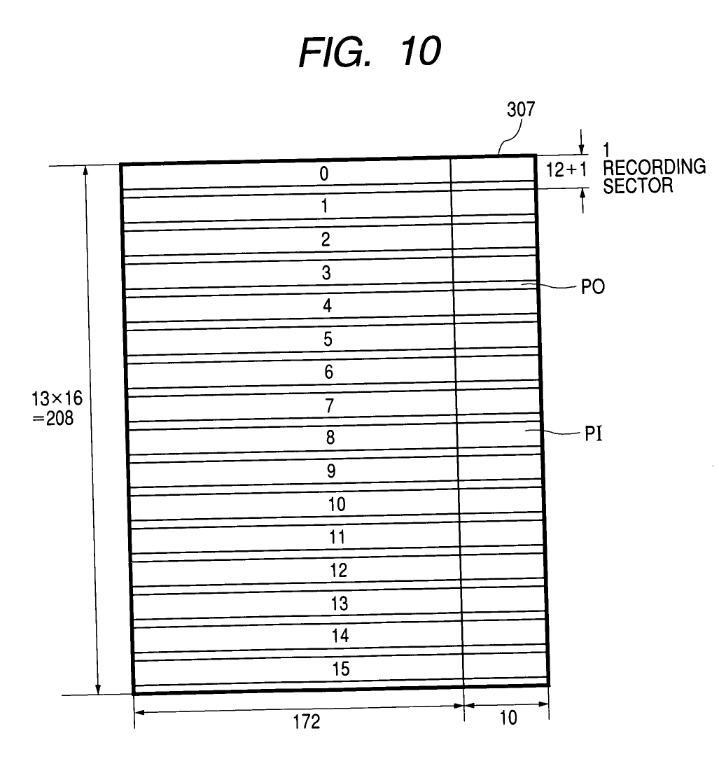

FIG. 10 shows a structure of the ECC block after the interleaving.

The 2366 bytes of the interleaved recording sectors of 13 rows×182 bytes are successively modulated every row from the head with the SYNC code 701 added before the 0th row and the 91st row, thereby being capable of forming the physical sector 308. It is to be noted that modulation data comprising this SYNC code 701 and the following 91 bytes of data is generically referred to as an SYNC frame.

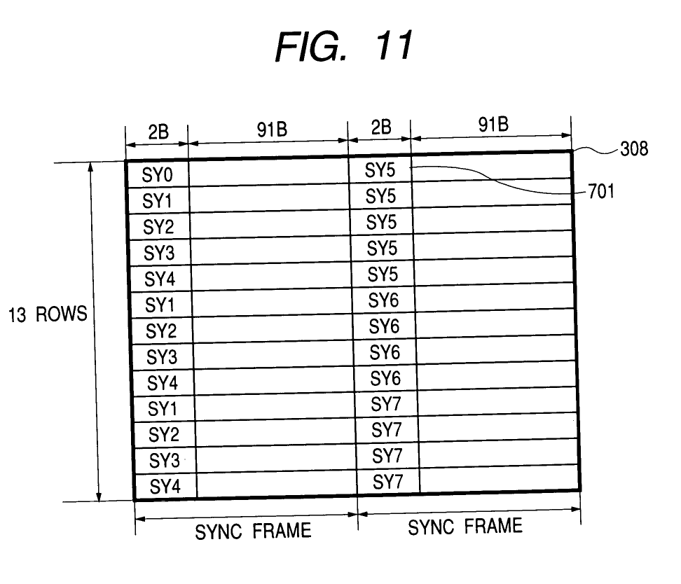

One physical sector is composed of 13 sets×2 SYNC frames as shown in FIG. 11, wherein 8/16 modulation for converting 8-bit input data to 16-channel-bit is performed, so that it is composed of (2 bytes+91 bytes)×2×13 rows×16 bits/byte=38688 channel-bit. The combination of the SYNC code 701 is shown in FIG. 11. The head of the sector can be specified by SYO (SYNC code “0”)or each row can be specified by the combination of cyclically repeated SY1 to SY4 and SY5, SY6 and SY7. The error correction is performed in ECC block units, so that it is formed by collecting 16 sectors. The ID information next to the SYO is read, whereby the head of the block is recogniz d by an address that can be divided by 16. Therefore, the SY0, i.e., the head of the sector is more important upon decoding the data. Further, the SY0 is specified by simultaneously using the other SYNC codes 701 with the use of periodicity.

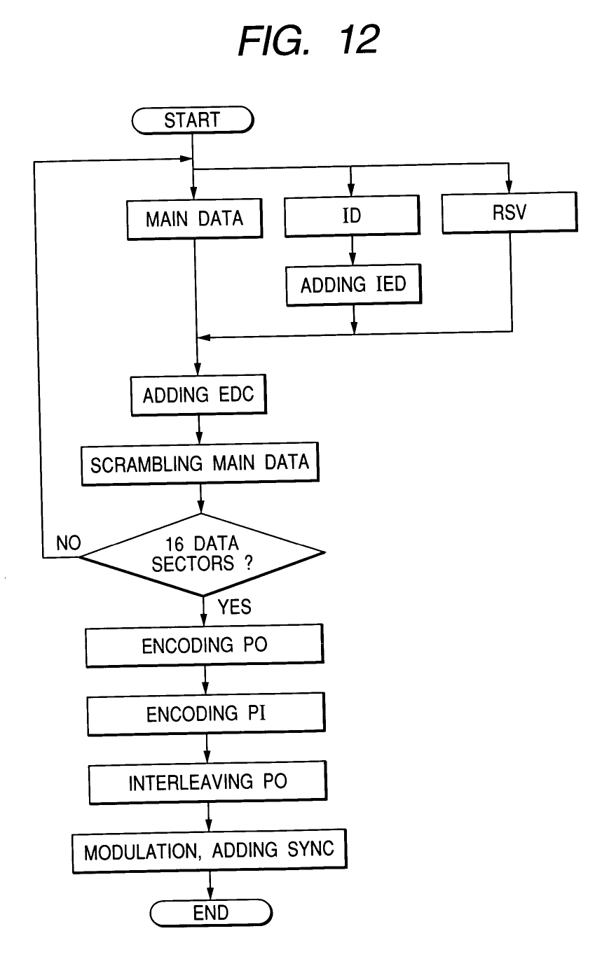

FIG. 12 is a flowchart showing a processing performed during a process for producing the recording data shown in FIG. 3.

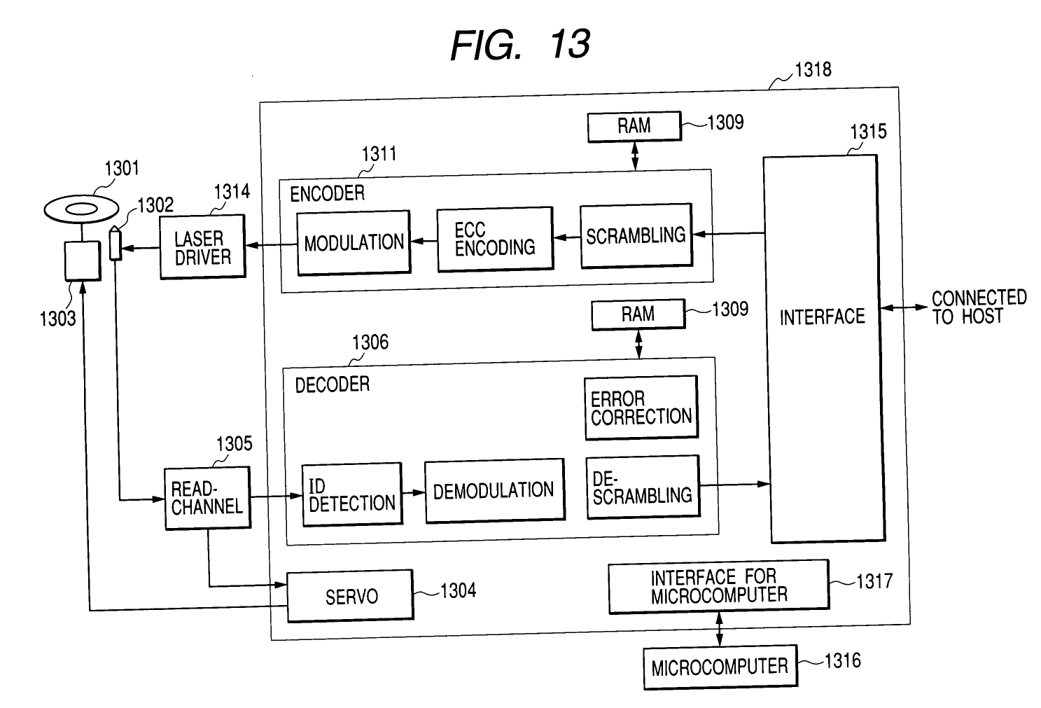

FIG. 13 is an example of a configuration of an optical disk recording/reproducing device taking a recordable DVD drive as one example. Numeral 1301 represents an optical disk, 1302 represents an optical pick-up that reads the data recorded on the optical disk 1301, 1303 represents a spindle motor for rotating the disk and 1314 represents a laser driver. Further, numeral 1304 denotes a servo controller for performing a control of the optical pick-up 1302 or the like. Numeral 1305 denotes a read-channel that performs an equalizer of an analog reproducing signal read by the disk 1301, binarization and generation of a synchronous clock, 1306 represents a decoder performing a process of demodulation, error correction, de-scrambling or the like of the read-out data and 1309 represents a RAM for temporarily storing the data. Numeral 1311 denotes an encoder performing a process of modulation, ECC encoding, scrambling or the like upon writing the data. Numeral 1315 denotes an interface that executes an input/output control to a host device and 1316 represents a microcomputer supervising the system. This configuration is shown by taking a DVD drive connected to a personal computer as an example, so that the interface 1315 means the connection to the personal computer, which means that it is disclosed as an example of connection to an MPEG board or HDD (Hard Disk Drive). It is needless to say that the configuration of the recording/reproducing device is not limited to this, and the subject to be connected is not specifically limited but may be a receiver such as an STB (set top box) or other image/voice recording/reproducing device. Further, the connection devices controlling the drive is generically referred to as a host in the explanation.

A random access is given as one of features of the optical disk.

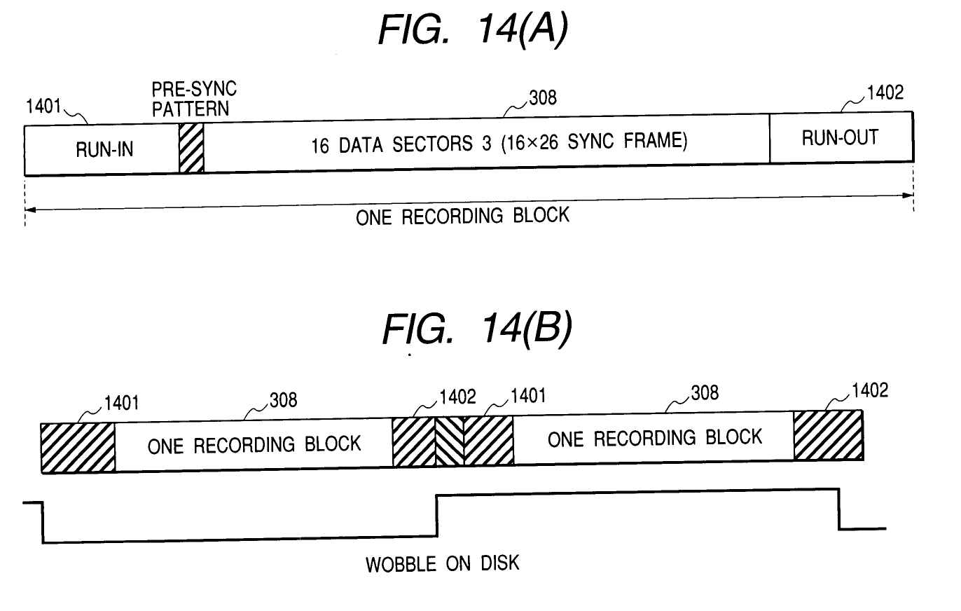

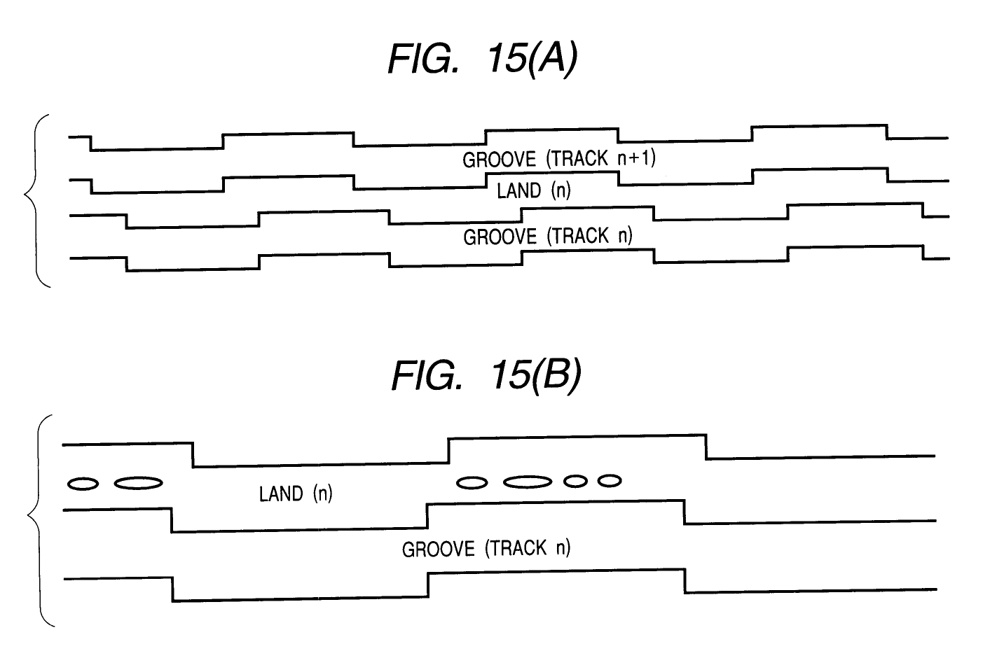

Explained with reference to FIGS. 14 and 15 are a physical mechanism of the disk for realizing this random access upon the recording, i.e., a physical address showing the position on the disk, or how to arrange the data sector 3 produced in the processing flow of FIG. 3 on the disk.

FIGS. 14 represent that one recording block is defined by a data column wherein a run-in composed of a fixed pattern and a pre-sync pattern showing the head of the 16 data sectors 3 are added at the front and a run-out is added at the rear of the 16 data sectors 3 produced in the process of FIG. 3 or a data row obtained by connecting 16 of 26 SYNC frames shown in FIG. 11 and that this recording block is arranged on the disk in synchronous with a wobbl on the disk while overlapping the run-out with the run-in. Specifically, this system represents that it is possible to randomly record data in one recording block unit without paying so much attention to the connection to the previous data or the following data.

In order to randomly record data on the disk, the physical address showing the position where the data is arranged is required on the entire surface of the disk. FIG. 15 are one example of the arrangement of the physical address. The data is recorded in a unit of one recording block in synchronous with the wobble. Accordingly, the physical address utilizes a center number of the head of the 16 data sectors 3 forming one recording block. Further, the wobble on the disk is made of grooves and lands each having concave/convex shape in a spiral manner from the inner periphery of the disk. The data is recorded on the groove corresponding to the concave section, while a pit that can be divided from the recording data from the view point of a frequency is arranged on the land section, whereby the physical address showing the position on the disk is formed. In the example shown in FIG. 15, one address is arranged in two recording blocks. In the optical disk recording/reproducing device shown in FIG. 13, the physical address outputs light for the physical address reproduction at the land section separately from light for recording/reproducing data following the groove from the pick-up 1302 upon the reproducing/recording, the light is converted into voltage by an exclusive optical detector or an IV amplifier like the recording data, and then, the resultant is detected by the decoder section 1306 via the read-channel 1305 to thereby be utilized for the reproduction and recording.

As described above, the physical address is arranged on the disk to enable the data to be recorded in one recording block unit, thereby realizing the random access or random recording of the optical disk.

Subsequently explained are a method for protecting the additional writing, its system and device of a recordable optical disk to which random recording is performed, in particular of an optical disk called a write-once type optical disk such as CD-R and DVD-R.

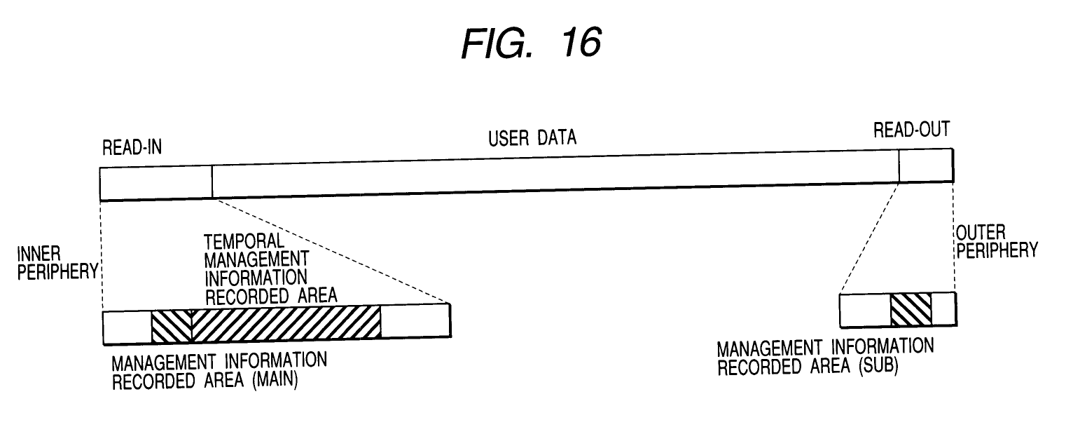

FIG. 16 is a side sectional view of a disk, showing that the disk is logically divided for use into areas on its inner periphery and outer periphery according to an object. The disk is divided into a read-in area that records management information or the like of the disk or drive, a user data area in which a host records data or management information about the data and a read-out area that, similar to the read-in area, records the management information or the like of the drive or the like from its inner periphery to its outer periphery. Further, a management information recorded area for recording the management information of the drive is present in the read-in and read-out areas, and a temporal management information recorded area is present for temporarily recording the management information in order to cope with the write-once type optical disk. Moreover, it is assumed that the management information recorded area has a size capable of recording only one set of the management information while the temporal management information recorded area has a recording size sufficient for renewing the management information. The reason why the management information recorded area is arranged at the inner periphery and outer periphery is to prevent a state wherein the entire disk cannot be reproduced when the data in the management information recorded area (main) at the inner periphery cannot be reproduced. Additionally, it is supposed that, in the write-once type optical disk, the temporal management information recorded area and two main and sub management information recorded areas are used as follows. In a case where the management information recorded area of this disk is non-recorded, an additional writing is allowed, so that the management information is always additionally written in the temporal management information recorded area. Further, the final management information in the temporal management information recorded area is copied to the management information recorded area at the timing when the additional writing to the disk is determined to be prohibited, and hence, the additional writing is prohibited when the management information is recorded in the management information recorded area (main) or the management information recorded area (sub).

A maximum recorded address (MRA) is included in the management information shown in FIG. 16.

It is to be noted that, in a single-layered optical disk such as CD or DVD, the user data is generally recorded from the inner periphery to the outer periphery from the viewpoint of the servo control, so that the MRA can be put in an outermost periphery recorded address.

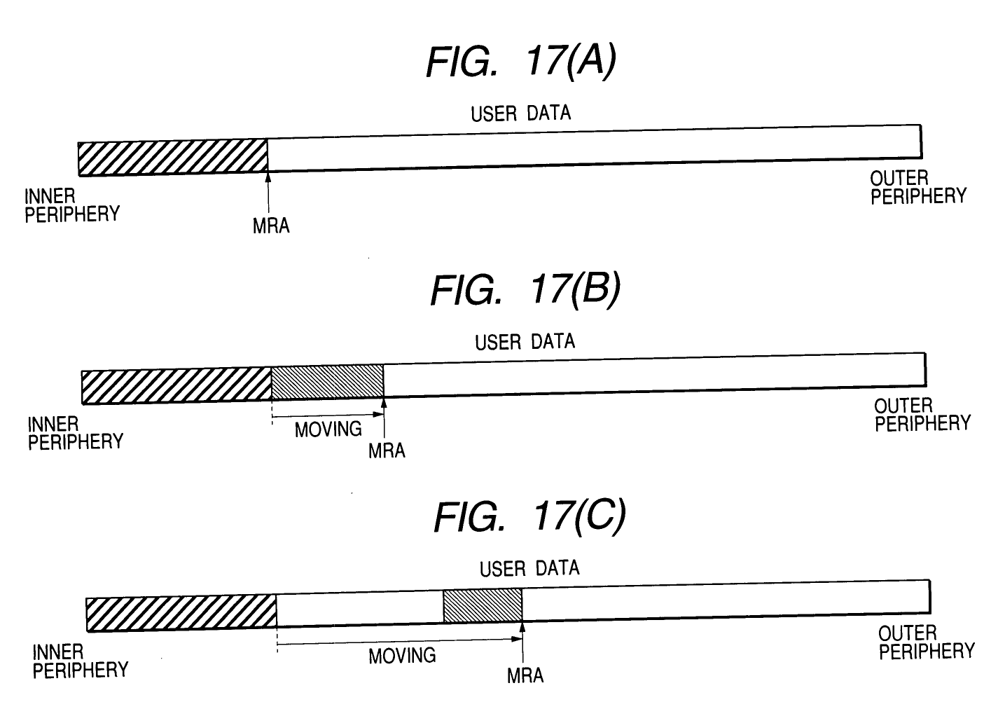

FIG. 17 are views showing values of the MRA with respect to the disk in each using state. In the following figures, a diagonal line in the upper rightward direction represents a recorded area, black-painted area represents a newly additionally written area and a white area represents a non-recorded area.

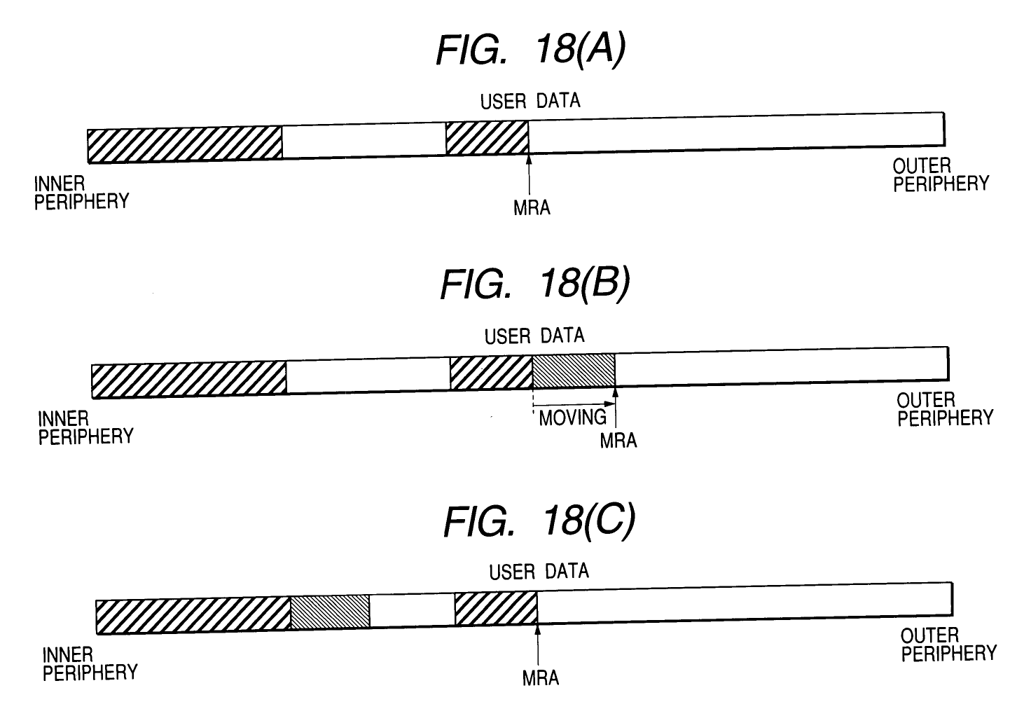

The MRA shown in the figures is the one positioned at the outermost periphery in the recorded address. In a case where the recording is continuously performed from the inner periphery of the disk as shown in FIG. 17A, the MRA represents the outermost periphery address of the recorded area where the last-recorded data is arranged, and in a case where the additional writing is continuously performed from the recorded area of FIG. 17A to become a state shown in FIG. 17B, the MRA moves to the outermost periphery of the newly recorded area. Similarly, also in a case where the data is recorded with the non-recorded area present therebetween, the MRA moves to the outermost periphery of the newly recorded area. A supplementary explanation is further made by using FIGS. 18. In a case where data is additionally written as shown from the state of FIG. 17C (FIG. 18A) to the state of FIG. 18B, the MRA moves to the outermost periphery of the newly recorded area, while in a case where data is additionally recorded in the recorded area positioned at the inner periphery as shown in FIG. 18C, the MRA does not move but indicates the same position as that in FIG. 18A.

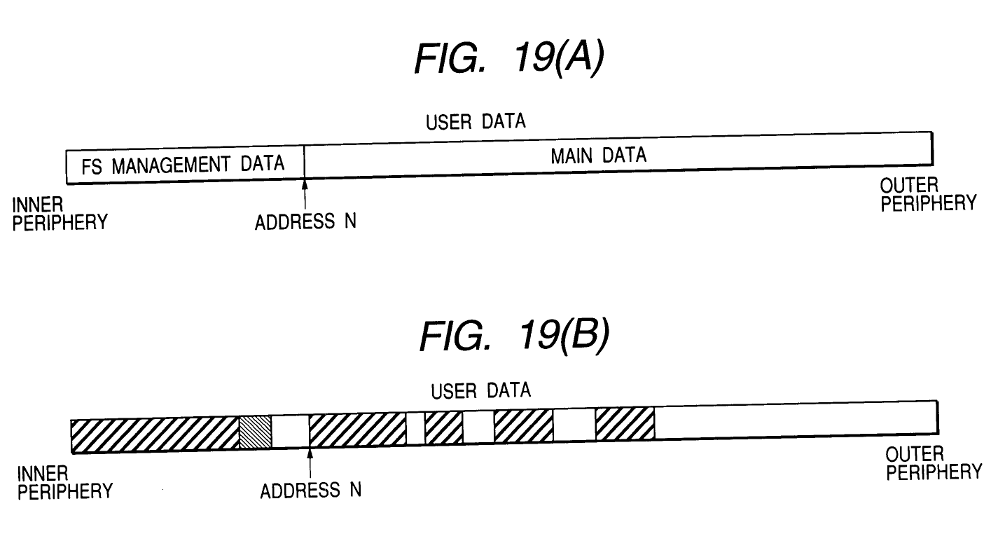

FIG. 19A is an example wherein the host uses the user data area by dividing it into two areas with an address N as a boundary from the inner periphery to the outer periphery (the drive does not recognize this), i.e., dividing it into an FS management data area in which data relating to the management information of the file system is arranged and a main data area that records data (file) transmitted from the host. The management information of the file system recorded in the FS management data area is information about a name of a file recorded in the main data area or its recording position or a directory structure or the like. FIG. 19B is a view showing a recording method of a disk used by classifying the user data area like FIG. 19A. The FS management data area is used such that the additional writing is performed thereto from the inner periphery to the outer periphery, and the data in the main data ar a is recorded in plural optional positions.

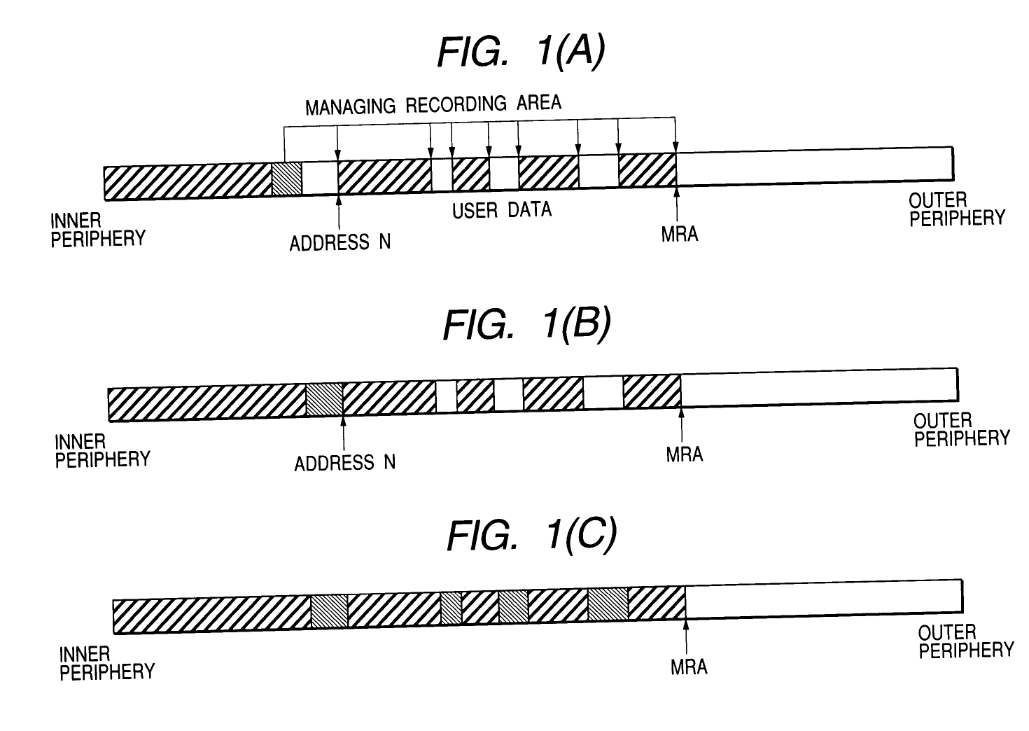

FIG. 1 are views for explaining a system wherein the additional writing is impossible to the disk having the FS management data area arranged in the inner periphery and the main data area arranged in the outer periphery as shown in FIG. 19. FIG. 1A is a view showing that the latest file system management information recorded in the FS management data area of FIG. 19 manages all recorded areas on the disk or the area having a necessary file recorded thereon. As a method for providing a state where the additional writing is impossible to this disk, the non-recorded area in the FS management data area is rendered to be a recorded unused area up to the address N as shown in FIG. 1B, thereby being capable of prohibiting the additional writing.

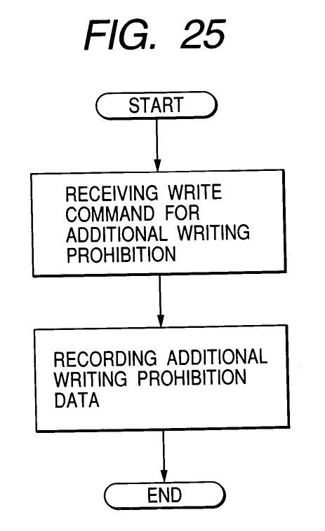

In order to realize this, an additional writing prohibition recording command is provided between the drive and the host, whereby the drive receives from the host the additional writing prohibition recording command, recording head address and recording block number or final recording address N, thereby recording additional writing prohibition data (interpreted as the unused area in the drive upon reproduction) produced in the drive. FIG. 25 is a flowchart showing this operation. When there is not unused area in the FS management data area, the management information of the file system is not renewed even by recording a new file in the user data area, whereby it is impossible to renew the main data, and consequently, the additional writing can be prohibited.

FIG. 1C is a view for explaining a method for performing the prohibition of the additional writing by changing the non-recorded area to the recorded unused area up to the MRA as the drive automatically detects the recorded state and non-recorded state.

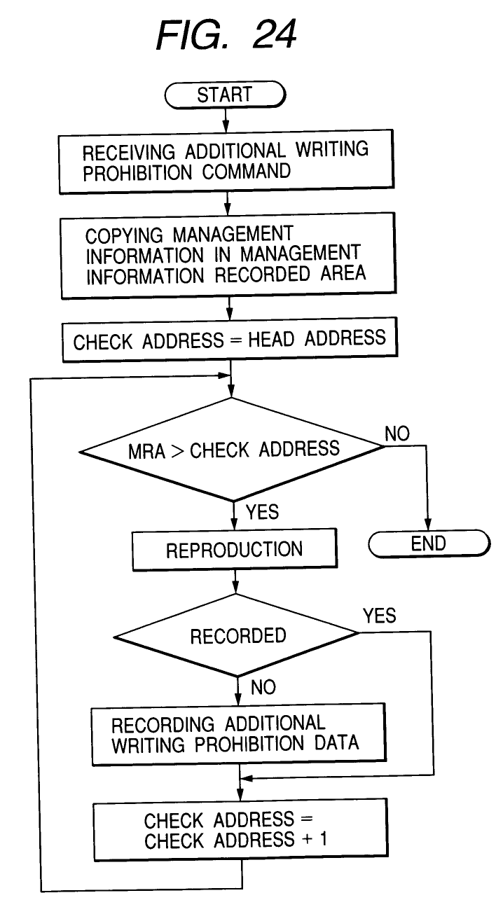

In order to realize this, an additional writing prohibition command is provided between the drive and the host, whereby the final management information in the temporal management information recorded area is copied in the management information recorded area when the drive receives this command from the host, then, as shown in a flowchart in FIG. 24, an address (check address) performing a check operation is set at the head address in the user data area, and the state of recorded or non-recorded at the position indicated by the check address is determined. In a case where it is in the non-recorded state, the additional writing prohibition data is recorded at the position indicated by the check address. After this operation, 1 is added to the check address, and while the check address is smaller than the MRA, a reproduction process and, according to need, a recording process are repeatedly performed.

After the completion of the processing, this results in a disk wherein the user area continuously becomes the recorded area up to the address indicated by the MRA from the innermost periphery as shown in FIG. 1C.

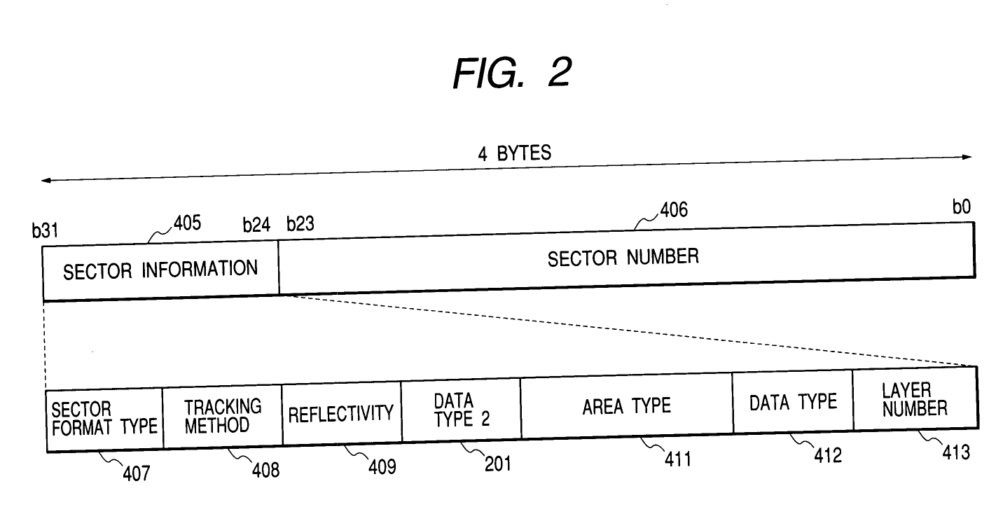

FIG. 2 is a view showing a data format of the additional writing prohibition data used for forming the recorded unused area used in the explanation of FIG. 1.

In a case where data type 2 is newly added to a space area of the sector information of the 6 bytes of the ID data in the DVD data format explained in FIG. 5 for representing the additional writing prohibition data, a flag is set up on this data, so that it is possible to discriminate this data from the conventional recording data. The additional writing prohibition data can be defined by other measures such as a method for setting a flag by using the reserve 403 area in FIG. 4 or a method of using a special pattern as the main data 305.

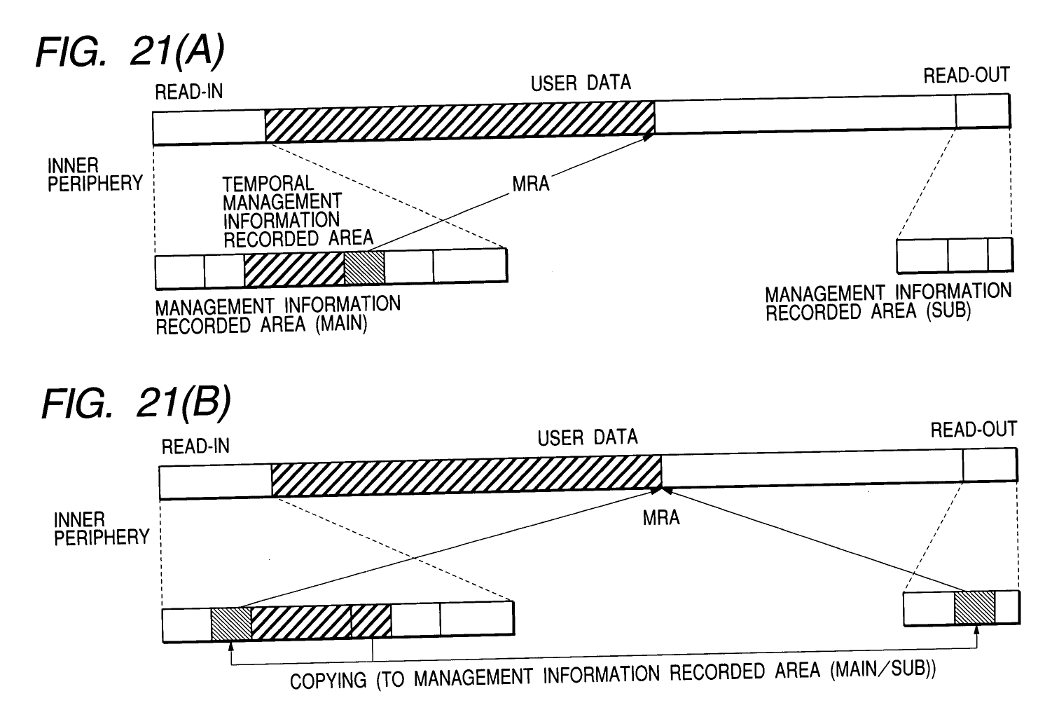

FIG. 21 are views showing an operation, included in the flowchart of FIG. 24, of copying the final management information in the temporal management information recorded area to the main and sub management information recorded areas. Upon receiving the additional writing prohibition command from the host, the drive copies the latest management information, that correctly shows the MRA, in the temporal management information recorded area to the management information recorded area. Accordingly, the drive determines whether or not the disk is subject to the additional writing prohibition process depending upon that th data is recorded in the management information recorded area.

Further, the MRA included in the management information recorded in the management information recorded area represents the boundary between the recorded area and non-recorded area in the user data.

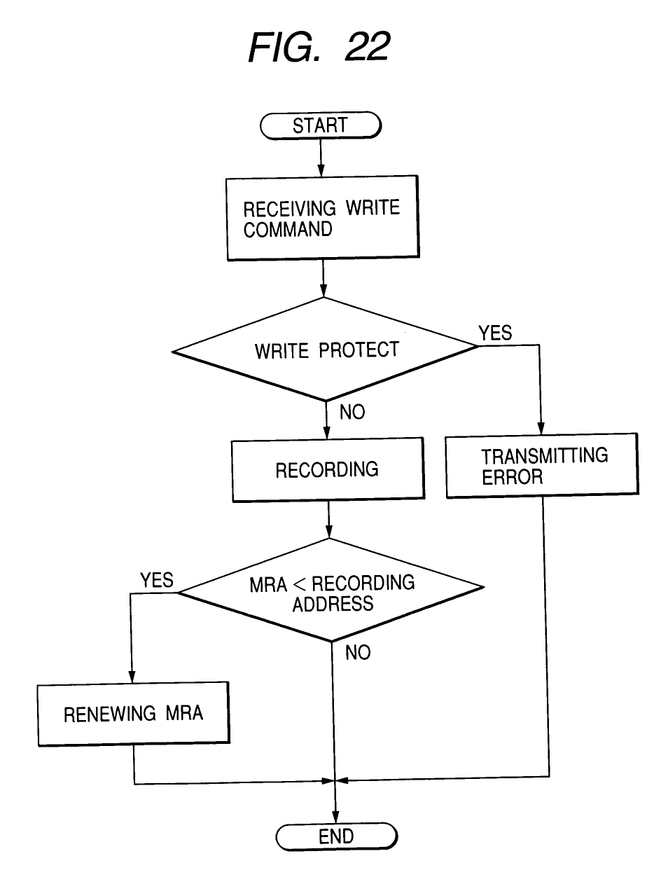

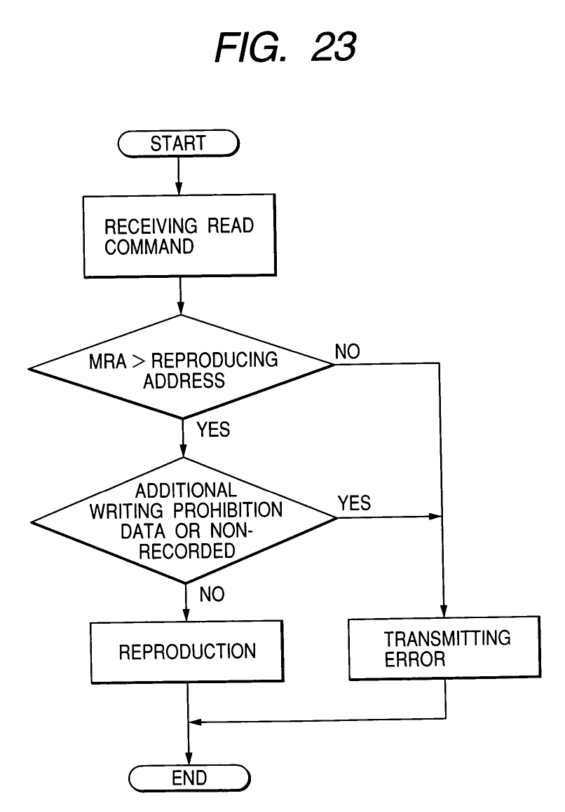

FIGS. 22 and 23 represent the recording and reproducing processes of the drive by flowcharts.

FIG. 22 shows the recording process, wherein the drive receiving the write command from the host confirms whether the management information is recorded in the management information recorded area of the disk. If the management information is present in the management information recorded area, it returns to the host an error showing that recording is impossible to this disk. In a case where the management information recorded area is not recorded, the drive performs a process for recording data to the address designated by the host, and then, compares this recording address with the MRA of the disk. In a case where the recording address is smaller than the MRA, it finishes the recording process, while it renews the MRA of the disk before finishing the recording process in a case where the recording address is greater than the MRA.

FIG. 23 shows the reproducing process, wherein the drive receiving the read command from the host confirms that the read command received from the host is smaller than the MRA recorded on the disk. In a case where the unused area flag is not added to the data, it reproduces data and transmits it to the host. However, in a case wher the designated address is greater than the MRA address or in a case where the data is the one to which the unused flag is added, the drive returns to the host an error showing that the reproduction is impossible.

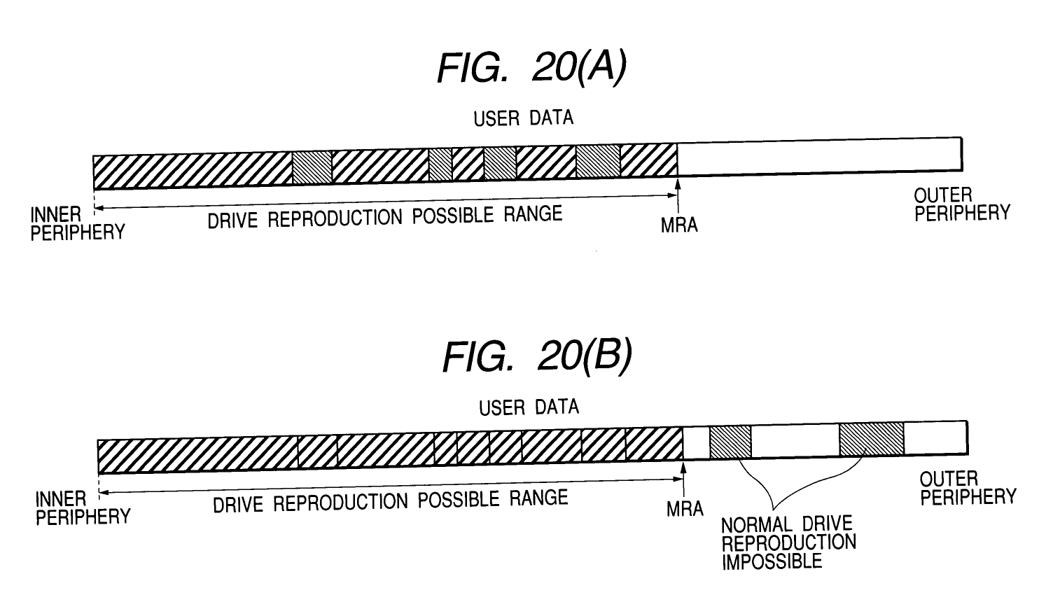

Finally shown by using FIG. 20 is that data irregularly recorded becomes non-reproducible in the drive.

FIG. 20A shows a recording state when the drive changes the non-recorded area to the recorded unused area with the additional writing prohibition data after receiving the additional writing prohibition command. FIG. 20B shows a state wherein, after that, an irregular recording is performed to this disk. In a case where such a disk is inserted into the drive, the drive reads the MRA recorded in the management information recorded area when the disk is inserted in the drive, and in order to allow only the reproduction to the address smaller than the MRA, the data recorded at the outer periphery than the MRA cannot be reproduced.

Accordingly, as described above, the additional writing prohibition function by the drive using the MRA can be realized with respect to all recording systems.

This system can be realized by the optical disk recording/reproducing device shown in FIG. 13.

The device technique relating to the present invention relates mainly to the microcomputer 1316 in the drive optical disk recording/reproducing device. The microcomputer has a program ROM at the inside or outside section, whereby it performs an operation according to a program recorded in this ROM. All of the commands from the host and the drive are interpreted at the microcomputer 1316 for controlling the other devices constructing the drive.

Consequently, the present invention can easily be realized by adding the function of the present invention to a program for a microcomputer ROM.

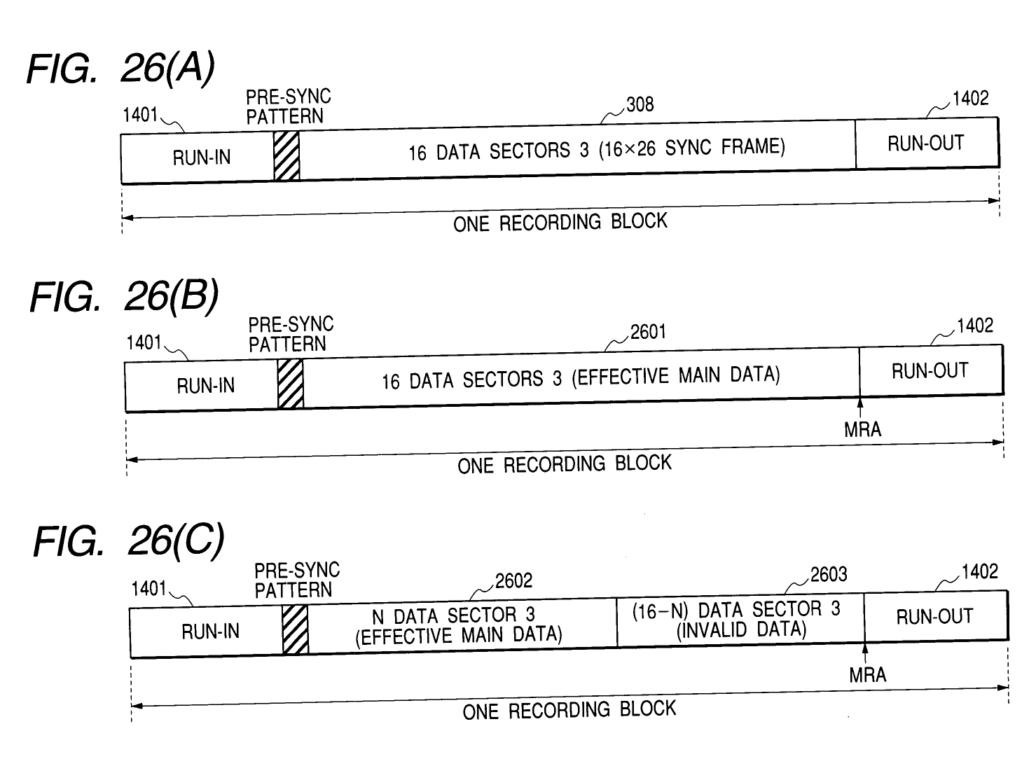

FIG. 26A represents that one recording block is defined by a data column wherein a run-in composed of a fixed pattern and a pre-sync pattern showing the head of the 16 data sectors 3 are added at the front and a run-out is added at the rear of the 16 data sectors 3 explained in FIGS. 14 or a data row obtained by connecting 16 of 26 SYNC frames shown in FIG. 11.

Further, FIGS. 26B and 26C are views showing a relationship between a position indicated by an address pointer showing the recording area on the disk such as the MRA or the like and substantial main data.

It is important that the address used for managing the recording area on the disk actually indicates the recording area on the disk. However, data is handled with 2 Kbytes, i.e., in the data sector upon the reproduction or recording in a general PC. Accordingly, the additional writing data does not satisfy the unit of one ECC of 32 Kbytes or a gap between the additional writing often becomes 2 k×N byte.

FIG. 26B shows the cas wherein 32 Kbytes is all the effective user data 2601, while FIG. 26C shows the case wherein only 2 k×N byte of the abovementioned 32 Kbytes is only the effective user data 2602 and the remaining data is invalid data 2603 optionally produced by the drive.

The operation of the drive is explained by using the optical disk recording/reproducing device shown in FIG. 13.

The main data sent from the host with the recording command via the interface 1315 is temporarily stored in the RAM 1309 connected to the encoder 1311 until data of 32 Kbytes is all together. Since the recording command from the host is continuously generated in general, the main data stored in the RAM 1309 is subject to the remaining scrambling, ECC encoding and modulation process in 32 Kbytes, and then, recorded on the disk 1301.

However, in a case where the host desires to record only the 8 Kbytes of the user data on the disk 1301, for example, a compulsory recording command is transmitted to the drive for forcibly recording the data stored in the RMA 1309. At this time, the drive automatically produces optional additional data as the remaining 24 Kbytes of data and forcibly produces 32 Kbytes of the main data that is subject to the remaining scrambling, error correction coding and modulation process to thereby be recorded on the disk 1301 like the normal process.

Therefore, in this circumstance too, the technique explained in FIG. 2 is utilized and the algorithm used in FIG. 23 is appli d.

Specifically, among the data sectors composed like those shown in FIG. 26C, a flag for discriminating the effective user data from the invalid data generated optionally by the drive is added to each data sector 3 in one recording block, whereby the invalid data is handled similar to the additional writing prohibition data as this discrimination flag is detected during the reproduction.

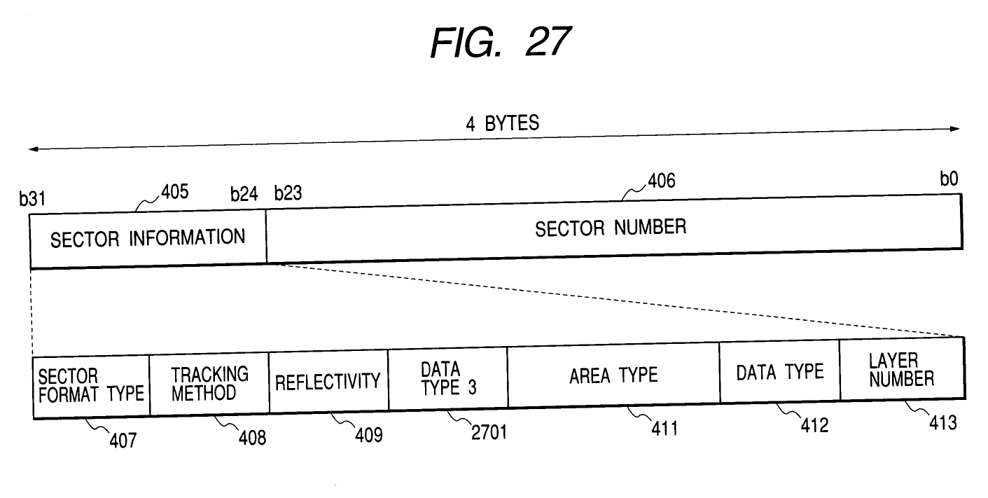

FIG. 27 is a view showing a data format of the ID including a data type 3 2701 for discriminating the effective user data from the invalid data used in the explanation of FIG. 26.

The data type 3 2701 is newly added to the reserved area of the sector information of 6 bytes of ID data in the DVD data format explained in FIG. 5. In a case where the invalid data optionally generated in the drive is shown, a flag is set up to this data type, thereby being capable of discriminating the invalid data from the conventional main data. Further, the invalid data can also be defined by other measures, i.e., by using the reserve 403 area in FIG. 4 or using a part of the SYNC code 701 for setting up the flag. Moreover, in a case where there is the management data given in recording block units, the flag relating to all data sectors in one recording block may be managed collectively or all data sector information included in one recording block may be recorded in the management area in sector units.

Although the ID 401 is used here, a flag having a more detailed unit than one recording block may be set up to the data area showing the sector information, thereby enabling address administration in one recording block unit and address administration in a unit that is obtained by dividing one recording block.

Applying the present invention can realize one of the features of the conventional write-once type optical disk, such as recording data cannot be changed and cannot be altered, with respect to an optical disk wherein a recording system is not limited, without requiring so much time.

What is claimed is:

1. A data recording method to record data on a recording medium in accordance with a recording request from a host, wherein
recording is performed by giving different identification data between a case where user data is recorded on the recording medium in accordance with the recording request from the host and a case where additional writing prohibition data is recorded on the recording medium in accordance with an additional writing prohibition request from the host.

2. A data recording method to record data on a recording medium having an address in accordance with a recording request from a host, wherein
user data and first identification data are recorded on said recording medium in accordance with the recording request from the host;
an address value of an outermost periphery among recorded addresses used for recording the user data is recorded on said recording medium; and
additional writing prohibition data and second identification data are recorded at a non-recorded address position that is at an inner periphery than the address value of said outermost periphery of said recording medium in accordance with the additional writing prohibition request from the host.

3. The recording method according to claim 2, wherein the address value of the outermost periphery recorded on said recording medium is stored at a predetermined position of said recording medium in accordance with the additional writing prohibition request from the host.

4. The recording method according to claim 1, wherein said identification data has a flag added in said identification data.

5. The recording method according to claim 3, wherein, when recording is requested from the host, recording is not performed to the recording medium in which the address value of the outermost periphery is stored at the predetermined position in accordance with the additional writing prohibition request from said host.

6. A data reproducing method for reproducing data of a recording medium having an address value of an outermost periphery stored at a predetermined position in accordance with an additional writing prohibition request from a host, wherein
an address value requested to be reproduced from the host and the address value of the outermost periphery stored at the predetermined position of said recording medium are compared and in a case where the requested address value is positioned at an outer periphery than the address value of the outermost periphery, reproduction is not performed.

7. The data reproducing method according to claim 6, wherein, with respect to the recording medium having user data and first identification data recorded in accordance with a recording request from the host and having additional writing prohibition data and second identification data recorded in accordance with the additional writing prohibition request from the host, the identification data is read in accordance with the reproducing request from the host, and in a case of the second identification data, the reproduction of the additional writing prohibition data is not performed.

8. A data recording device to record data on a recording medium in accordance with a recording request from a host, wherein
recording is performed by giving different identification data between a case where user data is recorded on the recording medium in accordance with the recording request from the host and a case where additional writing prohibition data is recorded on the recording medium in accordance with an additional writing prohibition request from the host.

9. A data recording device to record data on a recording medium having an address in accordance with a recording request from a host, comprising:
an encoder that produces first identification data in accordance with the recording request of user data from the host and second identification data in accordance with an additional writing prohibition request from the host; and
an optical pick-up that records the user data and the first identification data on said recording medium in accordance with the recording request of the user data from the host, records an address value of said outermost periphery among recorded addresses used for recording the user data and records additional writing prohibition data and the second identification data at a non-recorded address position that is positioned at an inner periphery than the address value of said outermost periphery of said recording medium in accordance with the additional writing prohibition request from the host.

10. The data recording device according to claim 9, wherein the address value of the outermost periphery recorded on said recording medium is reproduced from said recording medium and recorded on a predetermined position on the recording medium in accordance with the additional writing prohibition request from the host.

11. The data recording device according to claim 8, wherein said identification data has a flag added in said identification data.

12. The data recording device according to claim 10, wherein, when recording is requested from the host, recording is not performed to the recording medium in which the address value of the outermost periphery is stored at the predetermined position in accordance with the additional writing prohibition request from said host.

13. A data reproducing device for reproducing data of a recording medium having an address value of an outermost periphery stored at a predetermined position in accordance with an additional writing prohibition request from a host, wherein
an address value requested to be reproduced from the host and the address value of the outermost periphery stored at the predetermined position of said recording medium are compared and in a case where the requested address value is positioned at an outer periphery than the address value of the outermost periphery, reproduction is not performed.

14. The data reproducing device according to claim 13, wherein, with respect to the recording medium having user data and first identification data recorded in accordance with a recording request from the host and having additional writing prohibition data and second identification data recorded in accordance with the additional writing prohibition request from the host, the identification data is read in accordance with the reproducing request from the host, and in a case of the second identification data, the reproduction of the additional writing prohibition data is not performed.

15. A data recording method for recording data having a constant amount on a recording medium in accordance with a recording request from a host, wherein
in a case where user data having a constant amount is recorded on the recording medium in accordance with the recording request from the host, identification data 1 is added and data optionally produced by a drive is added to the user data with an amount not satisfying the constant amount on the recording medium in accordance with a compulsory recording request from the host, while in a case where data with a constant amount is recorded, the identification data 1 is added to the user data and identification data 2 is given to the added optional data to thereby be recorded.

16. A data reproducing method wherein, with respect to a recording medium having user data and first identification data recorded in accordance with a recording request from a host and having user data and first identification data recorded in accordance with a compulsory recording request from the host and data optionally added by a drive and second identification data, the identification data is read in accordance with a reproducing request from the host, and in a case of the second identification data, the reproduction of the additional data is not performed.

17. A data recording device for recording data on a recording medium having an address in accordance with a recording request from a host, comprising:
a memory circuit for temporarily storing user data transferred with the recording request from the host until the user data reaches a predetermined amount;
an additional data generating circuit for making the user data in the memory circuit have the predetermined amount in accordance with a compulsory recording request from the host;
an encoder that produces first identification data in accordance with the recording request of the user data from the host as well as the first identification data and second identification data in accordance with the compulsory recording request from the host; and
an optical pick-up that records the user data and the first identification data on said recording medium in accordance with the recording request of the user data from the host and records the user data and the first identification data stored in said memory circuit in accordance with the compulsory recording request from the host as well as the additional data produced by said additional data generating circuit and the second identification data.
